(19) United States
(12) Patent Application Publication
(10) Pub. No.: US 2026/0148401 A1
(43) Pub. Date: May 28, 2026

(54) DEPTH SENSING SYSTEM AND DEPTH SENSING METHOD THEREOF

(71) Applicant: HIMAX TECHNOLOGIES LIMITED, Tainan City (TW)

(72) Inventors: Hsueh-Tsung LU, Tainan City (TW); Wu-Feng CHEN, Tainan City (TW)

(21) Appl. No.: 18/960,695

(22) Filed: Nov. 26, 2024

(51) Int. Cl. G06T 7/55; G06F 1/08; G06V 10/22; G06V 10/80; G06V 10/82

(52) U.S. Cl. CPC G06T 7/55; G06F 1/08; G06V 10/235; G06V 10/80; G06V 10/82

(57) ABSTRACT

A depth sensing system and depth sensing method thereof are provided. The depth sensing system includes a processor, a clock modulation circuit, a depth decoding circuitry, and a depth fusion circuit. The processor compares a first image and a second image for detecting a change region and a non-change region and counting a number of pixels in the change region. The clock modulation circuit generates a clock signal based on the number of the pixels in the change region. The depth decoding circuitry calculates depth values corresponding to the pixels in the change region based on the clock signal. The depth fusion circuit fuses the first image and the second image for generating depth information of the second image. The depth values in the non-change region of the first image and the depth values in the change region of the second image are integrated as the depth information.

### BACKGROUND

### Technical Field

The disclosure relates to a depth sensing system and a depth sensing method thereof, and more particularly to a depth sensing system having a function of dynamically adjusting a clock signal for decoding and a depth sensing method thereof.

### Description of Related Art

In depth sensing applications, an entire scene, a target, or other objects captured in an image are typically decoded to output depth values corresponding to all pixels in the image. However, in backend applications, only the target or the desired region of the target in the image may need to be extracted. If all pixels in the image are decoded in the same decoding process, the decoding time and power consumption cannot be reduced.

### SUMMARY

An objective of the present disclosure is to provide a depth sensing system. The depth sensing system includes a processor, a clock modulation circuit, a depth decoding circuitry, and a depth fusion circuit. The processor is configured to compare a first image and a second image for detecting a change region and a non-change region in the second image and counting a number of pixels in the change region, in which the second image is a next frame of the first image. The clock modulation circuit is configured to generate a clock signal based on the number of the pixels in the change region. The depth decoding circuitry is configured to calculate depth values corresponding to the pixels in the change region of the second image based on the clock signal. The depth fusion circuit is configured to fuse the first image and the second image for generating depth information of the second image, in which depth values in the non-change region of the first image and the depth values in the change region of the second image are integrated as the depth information.

Another objective of the present disclosure is to provide a depth sensing method. The depth sensing method is performed by a depth sensing system and includes obtaining a first image and a second image, in which the second image is a next frame of the first image, and several first pixels of the first image correspond to several second pixels of the second image; comparing the first image and the second image to detect a change region and a non-change region in the second image and count a number of the second pixels in the change region; generating a clock signal based on the number of the second pixels in the change region; calculating depth values corresponding to the second pixels in the change region of the second image based on the clock signal; and fusing the first image and the second image to generate depth information of the second image, in which depth values in the non-change region of the first image and the depth values in the change region of the second image are integrated as the depth information.

### BRIEF DESCRIPTION OF THE DRAWINGS

FIG. 1 is a schematic diagram showing a depth sensing system in accordance with an embodiment of the present disclosure.

FIG. 2 is a schematic diagram showing a detailed structure of the depth sensing system in accordance with an embodiment of the present disclosure.

FIG. 3 is a schematic diagram showing a detailed structure of the depth sensing system in accordance with another embodiment of the present disclosure.

FIG. 4 is a schematic diagram showing a depth sensing method in accordance with an embodiment of the present disclosure.

FIG. 5A is a schematic diagram showing a first image including a target in accordance with an embodiment of the present disclosure.

FIG. 5B is a schematic diagram showing a second image including the target in accordance with an embodiment of the present disclosure.

FIG. 6A is a schematic diagram showing a first image including a target and a desired region thereof in accordance with an embodiment of the present disclosure.

FIG. 6B is a schematic diagram showing a second image including the target and the desired region thereof in accordance with an embodiment of the present disclosure.

### DETAILED DESCRIPTION

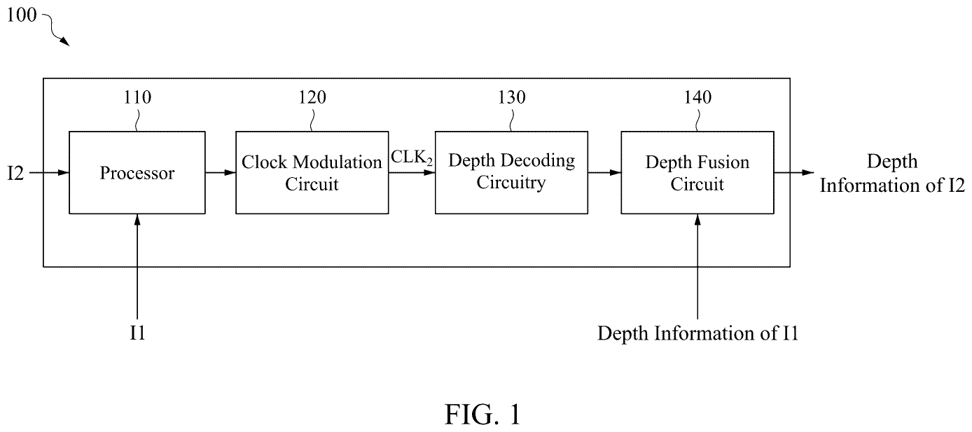

Referring to FIG. 1, FIG. 1 is a depth sensing system 100 in accordance with an embodiment of the present disclosure. The depth sensing system 100 includes a processor 110, a clock modulation circuit 120, a depth decoding circuitry 130, and a depth fusion circuit 140.

The processor 110 is configured to compare a first image I1 and a second image I2 for detecting a change region and a non-change region in the second image I2 and counting a number of pixels in the change region. The second image I2 is a next frame of the first image I1. For example, the first image I1 is an image of the n^{th} frame, and the second image I2 is an image of the (n+1)^{th} frame. The first image I1 and the second image I2 may be compared in terms of structured light patterns, structured light images, flood light images, or the like, and the present disclosure is not limited thereto.

The clock modulation circuit 120 is configured to generate a clock signal CLK₂ based on the number of the pixels in the change region. Specifically, based on the comparison of the first image I1 and the second image I2, the clock modulation circuit 120 may generate the clock signal CLK₂ required for decoding by the depth decoding circuitry 130 based on the number of pixels in the change region.

In the embodiment of the disclosure, the equation of the clock signal CLK₂ is as follows:

$${CLK}_{2} = {CLK}_{1} \times \frac{{P}_{C}}{{P}_{T}} = {CLK}_{1} \times \frac{{P}_{C}}{( {P}_{C} + {P}_{NC} )} ,$$

in which CLK₁ is an initial clock signal (or a main clock signal) provided to the depth decoding circuitry 130 for decoding, P_{C} is the number of the pixels in the change region of the second image I2, P_{NC} is the number of the pixels in the non-change region of the second image I2, and PT is a total number of the pixels in the change region and the non-change region of the second image I2.

It can be found that the clock signal CLK₂ provided to the depth decoding circuitry 130 decreases as the number of the pixels in the change region decreases, and the clock signal CLK₂ provided to the depth decoding circuitry 130 increases as the number of the pixels in the change region increases. In some embodiments, the relationship between the number of pixels in the change region and the clock signal CLK₂ may further be constructed as a lookup table and stored in the clock modulation circuit 120, which may be used to quickly generate the required clock signal CLK₂ based on the number of pixels in the change region. An exemplary lookup table is expressed as follow:

| Number of pixels in | |
|---|---|
| the change region | Frequency of clock |
| P_{C} (pcs) | signal CLK₂ (MHz) |
| 307,200 | 24 |
| 153,600 | 12 |
| 76,800 | 6 |
| 38,400 | 3 |

The depth decoding circuitry 130 is configured to calculate depth values corresponding to the pixels in the change region of the second image I2 based on the clock signal CLK₂. The clock signal CLK₂ is adjusted based on the number of pixels in the change region, such as reducing a frequency of the clock signal CLK₂, effectively reduces power consumption compared to decoding using the initial clock signal CLK₁.

The depth fusion circuit 140 is configured to fuse the first image I1 and the second image I2 for generating depth information of the second image I2. The depth information of the second image I2 is generated by integrating depth values in the non-change region of the first image I1 and the depth values in the change region of the second image I2. In other words, the depth values of the pixels in the non-change region (compared to the first image I1) of the second image I2 may follow the depth information of the first image I1, while the depth values of the pixels in the change region (compared to the first image I1) of the second image I2 are obtained after decoding by the depth decoding circuitry 130. By substituting the depth values of the pixels in the change region between the first image I1 and the second image I2, the depth information of the second image I2 can be obtained.

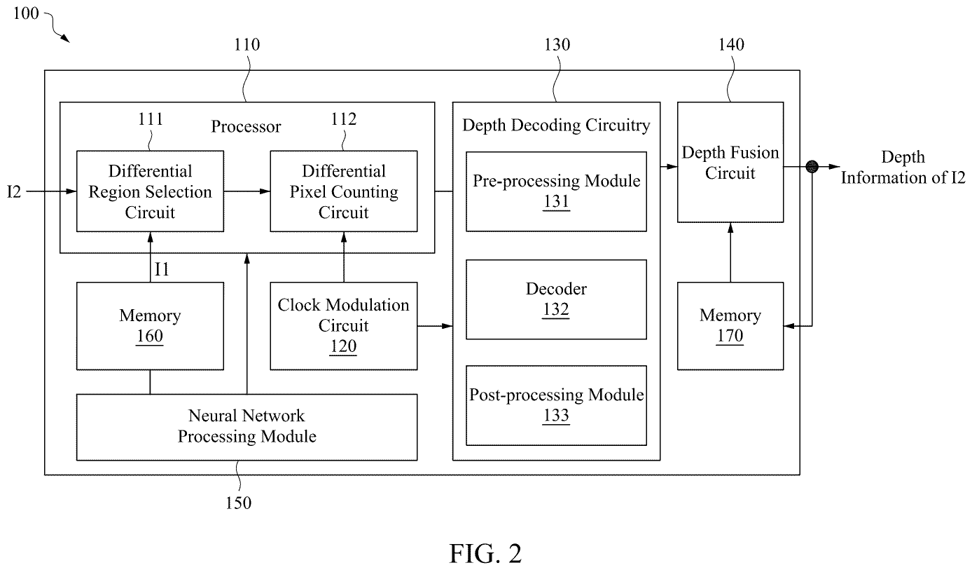

Referring to FIG. 2, FIG. 2 is a schematic diagram showing a detailed structure of the depth sensing system 100 in accordance with an embodiment of the present disclosure. The depth sensing system 100 further includes a neural network processing module 150, and memories 160 and 170.

The neural network processing module 150 is electrically connected to the processor 110 and is configured to detect a desired region of a target in the second image I2 to the processor 210 for determining whether the desired region of the target is the change region and counting the number of pixels in the desired region of the target. Specifically, the neural network processing module 150 may detect a region of interest (ROI), i.e., the desired region, of the second image I2 based on the needs of the application or the users. For example, the target is a person and the desired region is the face region of the person, the neural network processing module 150 may recognize and mark the face region on the second image I2 for further determining whether the desired region of the target is the change region and counting the number of pixels in the desired region of the target by the processor 110.

The memory 160 is configured to store the first image I1, and the memory 170 is configured to store the depth information of the first image I1. In some embodiments, the memory 160 and the memory 170 may be integrated into the same memory to store the first image I1 and the depth information of the first image I1. The processor 110 receives the first image I1 of the previous frame stored in the memory 160 and further compares it with the second image I2 received in the current frame. The depth information of the first image I1 output in the previous frame may be stored in the memory 170 and fused with the second image I2 in the current frame to output the depth information of the second image I2.

The processor 110 further includes a differential region selection circuit 111 and a differential pixel counting circuit 112. The differential region selection circuit 111 is electrically connected to the memory 160 and the differential pixel counting circuit 112 for receiving the first image I1 stored in the memory 160 and the second image I2, and outputting the detected change region in the second image I2 to the differential pixel counting circuit 112. The differential pixel counting circuit 112 is electrically to the depth decoding circuitry 130 and the clock modulation circuit 120 for counting the number of the pixels in the change region, modulating the clock signal CLK₂ based on the number of the pixels in the change region, and decoding the change region in the second image I2.

The differential region selection circuit 111 selects the change region in the second image I2 by comparing the first image I1 and the second image I2. In some embodiments of the disclosure, the differential region selection circuit 111 may determine the change region in the second image I2 by comparing a difference in brightness between each of the pixels in the first image I1 and a corresponding one of the pixels in the second image I2.

For example, when the difference in brightness between a pixel in the first image I1 and the corresponding one pixel in the second image I2 exceeds the threshold value, determining that the corresponding one pixel in the second image I2 is in the change region. Conversely, when the difference in brightness between the pixel in the first image I1 and the corresponding one pixel in the second image I2 does not exceed the threshold value, determining that the corresponding one pixel in the second image I2 is in the non-change region. As a result, the differential region selection circuit 111 may distinguish the change region and the non-change region in the second image I2. The threshold value may be adjusted or setting in accordance with the characteristics of the image sensor, the captured scene, or the actual application, and the present disclosure is not limited thereto.

The differential pixel counting circuit 112 counts the number of the pixels in the change region of the second image I2. Therefore, the clock modulation circuit 120 may generate the clock signal CLK₂ based on the number of the pixels in the change region by the equation or the lookup table of the clock signal CLK₂ mentioned above.

The depth decoding circuitry 130 includes a pre-processing module 131, a decoder 132, and a post-processing module 133. The pre-processing module 131 is configured to perform processes such as noise reduction, data normalization, and filtering to improve the quality and reliability of the second image I2 before decoding the change region in the second image I2 by the decoder 132. The post-processing module 133 is configured to perform processes such as smoothing, filling in missing data, filtering on the second image I2 after decoding the change region in the second image I2 by the decoder 132.

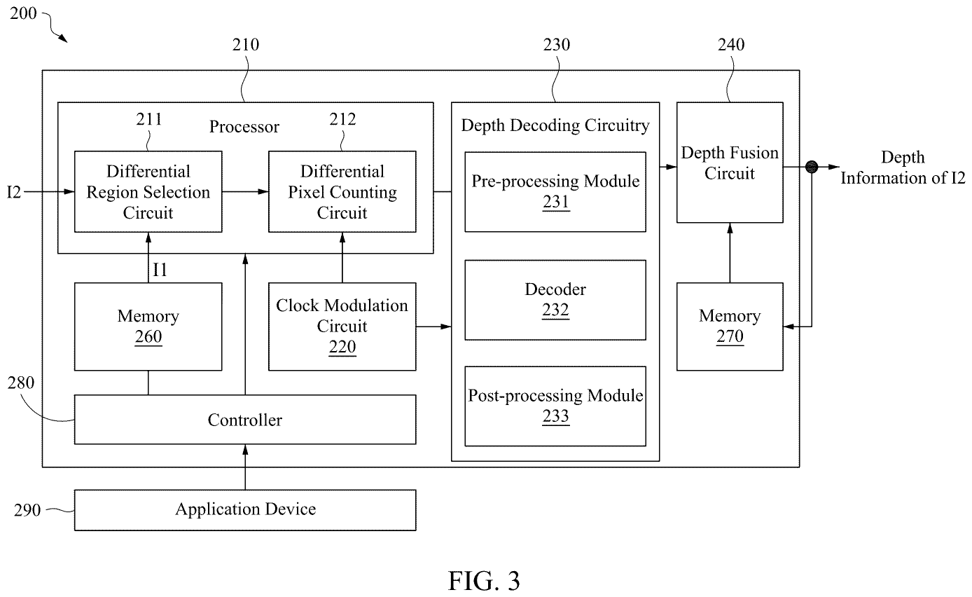

Referring to FIG. 3, FIG. 3 is a schematic diagram showing a detailed structure of the depth sensing system 200 in accordance with an embodiment of the present disclosure. The depth sensing system 200 includes a processor 210, a clock modulation circuit 220, a depth decoding circuitry 230, a depth fusion circuit 240, memories 260 and 270, a controller 280, and an application device 290. The difference between the depth sensing system 200 (shown in FIG. 3) and the depth sensing system 100 (shown in FIG. 2) is that the depth sensing system 200 does not include a neural network processing module, but instead includes the controller 280 and the application device 290. Other circuits and modules of the depth sensing system 200 and the functions thereof are similar to those described in the depth sensing system 100, and thus are not repeated herein.

In such embodiment, the application device 290 is configured to select the desired region of the target in the second image I2 by a user first, and the controller 280 transmits the second image I2 with the desired region of the target to the processor 210 for determining whether the desired region of the target is the change region and counting the number of pixels in the desired region of the target. In the embodiment of the disclosure, the application device 290 may be a personal computer (PC), a server, a mobile device, an industrial controller such as a programmable logic controller (PLC) and a distributed control system (DCS), or the like.

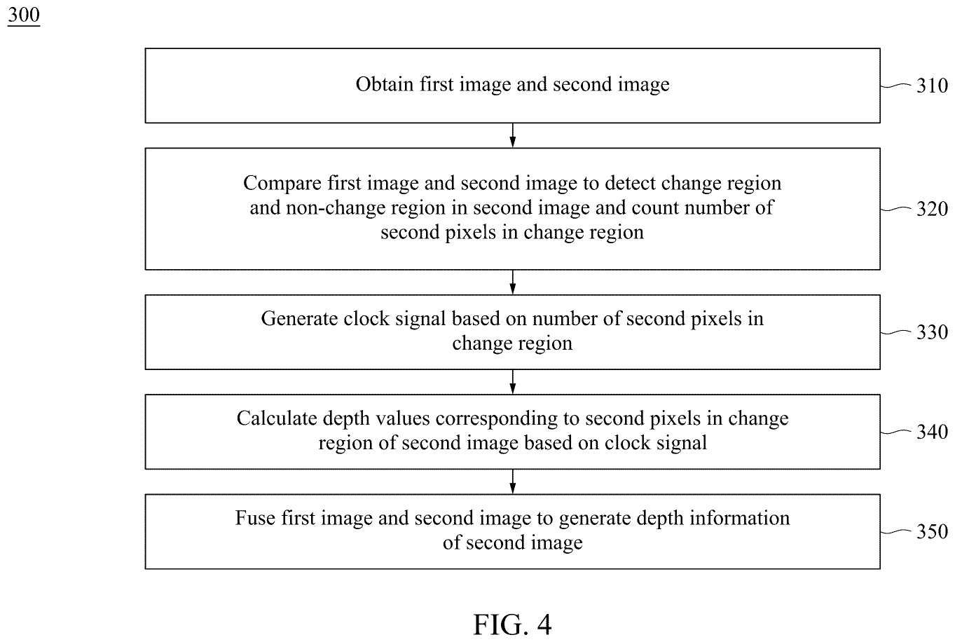

Referring to FIG. 4, FIG. 4 is a schematic diagram showing a depth sensing method 300 in accordance with an embodiment of the present disclosure. The depth sensing method 300 includes Steps 310 to 350, and these steps may be applied to the configuration shown in FIGS. 1 to 3 or another similar configuration. The configuration shown in FIGS. 1 and 2 are taken as an example for the following description.

At Step 310, a first image I1 and a second image I2 are obtained first. The first image I1 may represent an image in a previous frame, and the second image I2 may represent an image in a current frame next to the previous frame. The first image I2 in the previous frame may be stored in the memory 160 shown in FIG. 2. The first pixels of the first image I1 correspond to the second pixels of the second image I2 one by one.

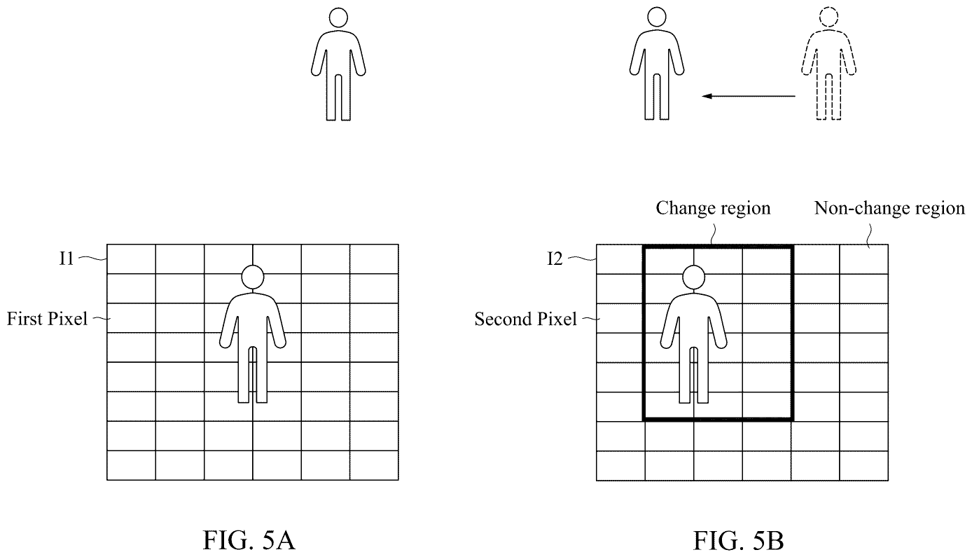

At Step 320, the second image I2 is compared with the first image I1 to detect a change region and a non-change region in the second image I2 and count a number of the second pixels in the change region by the processor 110. As shown in FIGS. 5A and 5B, a person (or a target) was captured in the first image I1 during the previous frame, and the person moving the position is captured in the second image I2 during the current frame. Based on the comparison of the first image I1 and the second image I2, the displacement region (or range of the seconds pixels involved) of the person can be detected as the change region, while the other range is detected as the non-change region. As a result, the number of the second pixels in the change region can be counted by the processor 110.

At Step 330, a clock signal CLK₂ is generated based on the number of the second pixels in the change region of the second image I2 by the clock modulation circuit 220. The clock signal CLK₂ may be generated by the equation or the lookup table of the clock signal CLK₂ as mentioned above, and the details are not described herein.

At Step 340, depth values corresponding to the second pixels in the change region of the second image I2 are calculated based on the clock signal CLK₂ by the depth decoding circuitry 130. Compared to decoding the depth values of all the second pixels in the second image I2, decoding only the second pixels in the change region not only helps to increase the speed of depth decoding, but also reduces the power consumption by decreasing the frequency of the clock signal CLK₂ required for decoding.

At Step 350, the first image I1 and the second image I2 are fused to generate depth information of the second image I2 by the depth fusion circuit 140. Specifically, the depth values in the non-change region of the first image I1 in the previous frame and the depth values in the change region of the second image I2 in the current frame are integrated as the depth information of the second image I2.

In an embodiment of the disclosure, the depth sensing method 300 further includes inputting the second image I2 into the neural network processing module 150 (shown in FIG. 2) to detect a desired region of a target in the second image I2 for further determining whether the desired region of the target is the change region. In an embodiment of the disclosure, the depth sensing method 300 further includes inputting the second image I2 into the application device (shown in FIG. 3) to select the desired region of the target in the second image I2 by a user for further determining whether the desired region of the target is the change region.

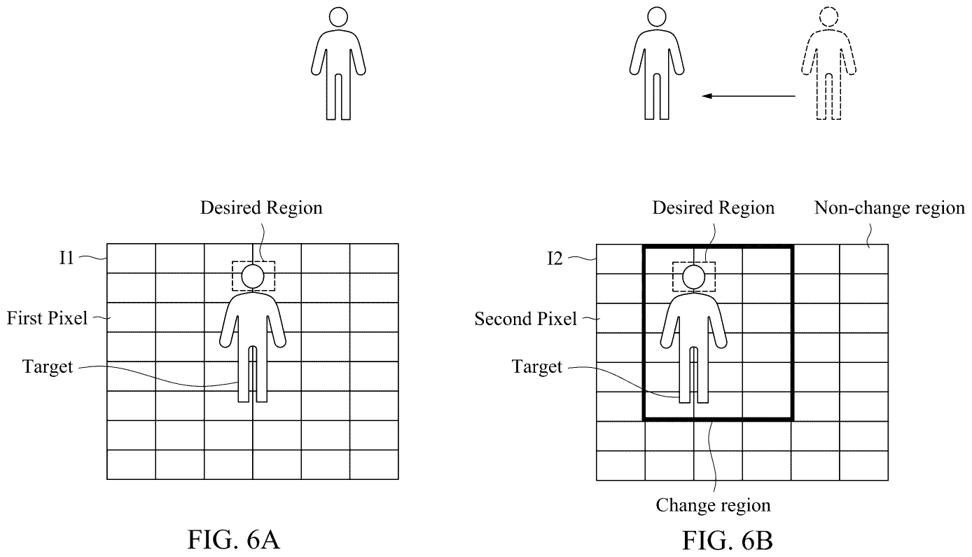

As shown in FIGS. 6A and 6B, the person is the target, and the desired region is the face (or head) region framed by the dotted line in the first image I1 and the second image I2. The target was captured in the first image I1 during the previous frame, and the person moving the position is captured in the second image I2 during the current frame. Based on the comparison of the first image I1 and the second image I2, the desired region is detected as the change region, and the number of the second pixels in the desired region can be counted by the processor 110. In such embodiment, the power consumption can be significantly reduced and/or the frame rate can be increased by calculating only the depth values of the second pixels in the desired region. For example, the desired region may be the human face, head, eyes, pupils, or the like, in order to significantly reduce the power consumption for calculating depth information in applications such as face recognition or pupil tracking.

In summary, the disclosure provides a depth sensing system and a depth sensing method thereof which dynamically adjusts the clock signal for decoding based on the detection of the change region and the non-change region in the image, thereby reducing the decoding time and the power consumption.

Although the description provided above is of various embodiments of the disclosure, this should not limit the scope of the disclosure. Those with ordinary skill in the art can make various modifications without departing from the spirit and scope of the disclosure. Therefore, the scope of protection of the present disclosure shall be determined by the following claims.

What is claimed is:

1. A depth sensing system, comprising:
a processor configured to compare a first image and a second image for detecting a change region and a non-change region in the second image and counting a number of pixels in the change region, wherein the second image is a next frame of the first image;
a clock modulation circuit configured to generate a clock signal based on the number of the pixels in the change region;
a depth decoding circuitry configured to calculate a plurality of second depth values corresponding to the pixels in the change region of the second image based on the clock signal; and
a depth fusion circuit configured to fuse the first image and the second image for generating depth information of the second image, wherein a plurality of first depth values in the non-change region of the first image and the second depth values in the change region of the second image are integrated as the depth information of the second image.

2. The depth sensing system of claim 1, further comprising:
a neural network processing module configured to detect a desired region of a target in the second image for determining whether the desired region of the target is the change region.

3. The depth sensing system of claim 1, further comprising:
an application device configured to select a desired region of a target in the second image by a user for determining whether the desired region of the target is the change region.

4. The depth sensing system of claim 1, further comprising:
at least one memory configured to store the first image and depth information of the first image.

5. The depth sensing system of claim 1, wherein the clock signal is generated by an initial clock signal, the number of the pixels in the change region, and a total number of the pixels in the change region and the non-change region.

6. The depth sensing system of claim 1, wherein the processor comprises:
a differential region selection circuit configured to select the change region in the second image by comparing the first image and the second image.

7. The depth sensing system of claim 6, wherein the processor comprises:
a differential pixel counting circuit configured to count the number of the pixels in the change region of the second image.

8. The depth sensing system of claim 1, wherein the clock modulation circuit is configured to generate the clock signal corresponding to the number of the pixels by referring to a lookup table.

9. The depth sensing system of claim 1, wherein a frequency of the clock signal decreases in response to the number of the pixels in the change region decreases, and the frequency of the clock signal increases in response to the number of the pixels in the change region increases.

10. A depth sensing method, performed by a depth sensing system, the depth sensing method comprising:
obtaining a first image and a second image, wherein the second image is a next frame of the first image, and a plurality of first pixels of the first image correspond to a plurality of second pixels of the second image;
comparing the first image and the second image to detect a change region and a non-change region in the second image and count a number of the second pixels in the change region;
generating a clock signal based on the number of the second pixels in the change region;
calculating a plurality of second depth values corresponding to the second pixels in the change region of the second image based on the clock signal; and
fusing the first image and the second image to generate depth information of the second image, wherein a plurality of first depth values in the non-change region of the first image and the second depth values in the change region of the second image are integrated as the depth information of the second image.

11. The depth sensing method of claim 10, further comprising:
inputting the second image into a neural network processing module of the depth sensing system to detect a desired region of a target in the second image for determining whether the desired region of the target is the change region.

12. The depth sensing method of claim 10, further comprising:
inputting the second image into an application device to select a desired region of a target in the second image by a user for determining whether the desired region of the target is the change region.

13. The depth sensing method of claim 10, further comprising:
comparing a difference in brightness between each of the first pixels and a corresponding one of the second pixels; and
determining that the corresponding one of the second pixels is in the change region in response to the difference in brightness between each of the first pixels and the corresponding one of the second pixels exceeding a threshold value.

14. The depth sensing method of claim 10, wherein the clock signal is generated by an initial clock signal, the number of the second pixels in the change region, and a total number of the second pixels in the change region and the non-change region.

15. The depth sensing method of claim 10, wherein generating the clock signal based on the number of the second pixels in the change region comprises:
determining the clock signal corresponding to the number of the second pixels by referring to a lookup table.

16. The depth sensing method of claim 10, wherein a frequency of the clock signal decreases in response to the number of the second pixels in the change region decreases, and the frequency of the clock signal increases in response to the number of the second pixels in the change region increases.
